(19) United States
(12) Patent Application Publication
(10) Pub. No.: US 2012/0144393 A1
(43) Pub. Date: Jun. 7, 2012

(54) MULTI-ISSUE UNIFIED INTEGER SCHEDULER

(75) Inventors: James Vinh, San Jose, CA (US); Kyle S. Viau, Fremont, CA (US); Michael L. Golden, Mountain View, CA (US); Ganesh Venkataramanan, Sunnyvale, CA (US)

(73) Assignee: ADVANCED MICRO DEVICES, INC., Sunnyvale, CA (US)

(21) Appl. No.: 12/957,861

(22) Filed: Dec. 1, 2010

(51) Int. Cl. G06F 9/46

(52) U.S. Cl. 718/102

(57) ABSTRACT

A method and apparatus for scheduling execution of instructions in a multi-issue processor. The apparatus includes post wake logic circuitry configured to track a plurality of entries corresponding to a plurality of instructions to be scheduled. Each instruction has at least one associated source address and a destination address. The post wake logic circuitry is configured to drive a ready input indicating an entry that is ready for execution based on a current match input. A picker circuitry is configured to pick an instruction for execution based the ready input. A compare circuit is configured to determine the destination address for the picked instruction, compare the destination address to the source address for all entries and drive the current match input.

### FIELD OF INVENTION

This invention relates to multi-issue processor execution unit architecture and in particular relates to an integer scheduler for use in a multi-issue processor.

### BACKGROUND

A basic processor includes several functional blocks. Such blocks typically include an instruction execution unit, a control unit, a register array and one or more system busses. The instruction execution unit can be divided into integer execution unit(s) and floating point execution unit(s).

The control unit generally controls the movement of instructions in and out of the processor, and also controls the operation of the instruction execution unit. The control unit generally includes circuitry to ensure everything happens at the correct time. Different portions of the control unit control the flow of instructions to the integer and floating point portions of the execution units. The register array provides internal memory that is used for the quick storage and retrieval of data and instructions. The system buses typically include control buses, data busses and address busses. The system busses are generally used for connections between the processor, memory and peripherals and transfer of data.

Modern processor architectures use multiple execution units typically arranged in a pipelined architecture. This allows the processor to execute several complex instructions per clock cycle. Each pipeline can simultaneously execute a separate instruction. However, simultaneous execution of instructions presents substantial timing problems. Some instructions are executed out of order. In some cases, the destination (or output) of one instruction may be required as a source (or input) for another instruction. The control circuitry that schedules execution of instructions can be complex and inefficient.

### SUMMARY

An apparatus and method for scheduling execution of instructions in a multi-issue processor. The apparatus includes logic circuitry configured to track a plurality of entries corresponding to a plurality of instructions to be scheduled. Each instruction has at least one associated source address and a destination address. The circuitry is configured to drive a ready input indicating an entry that is ready for execution based on a current match input;

The apparatus also has picker circuitry configured to pick an instruction for execution based the ready input. The apparatus also has compare circuitry configured to determine the destination address for the picked instruction, compare the destination address to the source address for all entries and drive the current match input. The apparatus can also include an age circuit configured to determine an oldest entry and drive an oldest input, wherein the picker circuitry is configured to pick an instruction for execution based the ready input and the oldest input.

Entries can be tracked in a fully decoded format. The compare circuitry can include a first memory decode circuitry configured to decode the destination address for the picked instruction and second memory decode circuitry configured to decode source addresses for each entry.

The apparatus can also include destination/source compare circuitry configured to compare the destination address for the picked instruction to all source addresses for each entry and drive the current match input. The apparatus can also include a destination broadcast bus configured to distribute the destination address to the destination/source compare circuitry. The first memory decode circuitry can include a decoder configured to decode the destination address for the picked instruction into a one-hot format. The second memory decode circuitry can also include a decoder configured to decode the source addresses for each entry into a one-hot format. The compare circuitry can include two stages configured to generate an 8-bit compare and can be configured to replicate a portion of the destination address for comparison to multiple source addresses.

### BRIEF DESCRIPTION OF THE DRAWINGS

FIG. 1 is a simplified block diagram of a processor core;

FIG. 2 is a simplified block diagram of an integer scheduler;

FIG. 3 is a simplified block diagram of the wake array and compare circuit;

FIG. 4 is a block diagram showing a more detailed drawing of the wake array and compare circuit.

FIG. 5 is a block diagram showing source ready circuitry; and

FIG. 6 is a block diagram showing duplication of the destination PRN to allow a 1:160 compare.

### DETAILED DESCRIPTION OF THE EMBODIMENTS

A typical processor is configured to execute a series of instructions selected from its associated instruction set. A computer program, typically written in a high level language (e.g., C++), is typically compiled into machine code or assembly language (i.e., into the instruction set for the given processor). The computer program is basically a set of instructions arranged in a specific order. In a general sense, a processor is tasked with executing the sequence of instructions in their original order. However, processors having multiple execution units can execute some of these instructions in parallel or otherwise out of order. Typically, the destination (or output) of one instruction is required as a source (or input) for another instruction. In order to address such timing issues, a scheduler is used to select instructions for execution. Schedulers can be provided for controlling integer instruction execution and floating point instruction execution. In a general sense, the scheduler determines whether a given instruction lacks one or more sources. In this case, the instruction is considered “not ready.” If the scheduler determines that an instruction has all sources available, such instructions are considered “ready.”

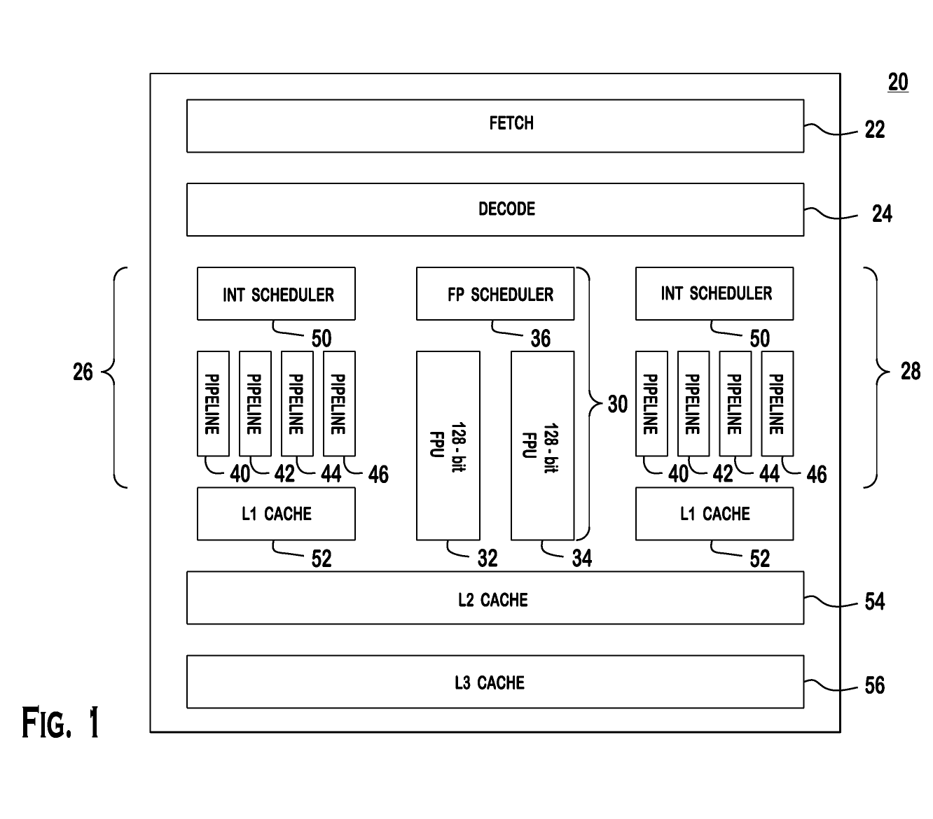

FIG. 1 shows a simplified block diagram of a processor core 20. In this example, the processor core 20 has an instruction fetch unit 22, an instruction decode unit 24, two integer execution units 26, 28 and a floating point execution unit 30. It should be understood that multiple processor cores can be used in a single processor.

The floating point execution unit 30 includes two 128-bit floating point units (FPU) 32, 34. Each FPU 32, 34 is configured to execute floating point instructions under control of a floating point scheduler 36. Each integer execution unit 26, 28 includes a plurality of pipelines 40, 42, 44 and 46 under control of an integer scheduler 50. The processor core 20 also has L1, L2 and L3 cache memories 52, 54, 56.

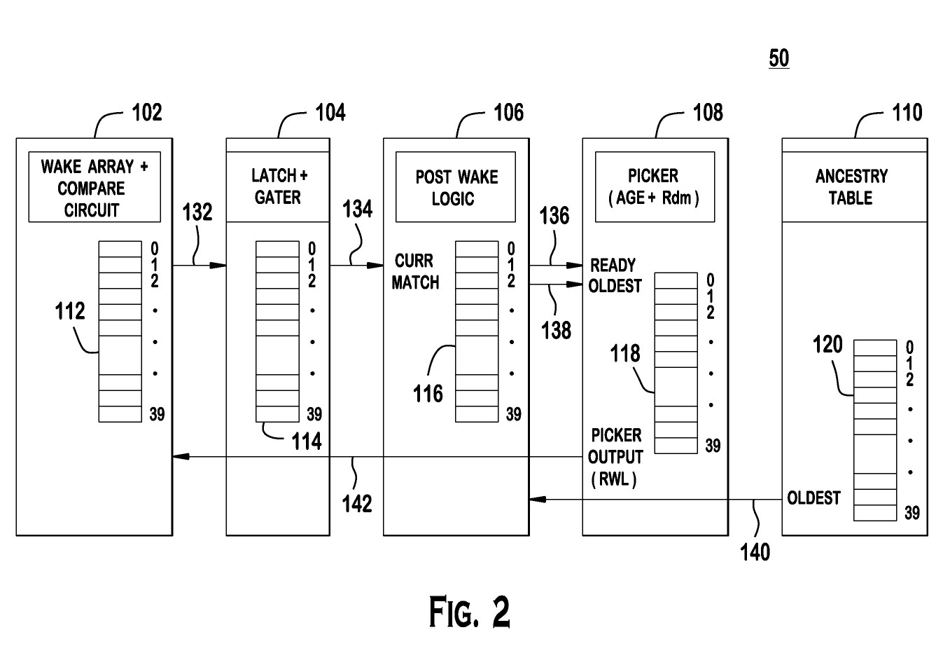

FIG. 2 is a simplified block diagram of an integer scheduler 50. It should be understood that the integer scheduler 50 can be used in a variety of processor architectures and is not limited to use with the processor core disclosed in FIG. 1. It should also be understood that an integer scheduler can perform other functions and can contain additional circuitry above and beyond what is disclosed herein. In this particular example, integer scheduler 50 is configured for use with four (4) pipelines and is therefore a four-issue integer scheduler. It should be understood that the integer scheduler 50 can be used with any number of pipelines. Accordingly, the disclosure contained herein is applicable to a multi-issue integer scheduler that can be associated with any number of pipelines.

The integer scheduler 50 includes: a wake array and compare circuit (wake array logic circuit) 102, a latch and gater circuit (latch circuit) 104, a post wake logic circuit 106, a picker 108 and an ancestry table (age array) 110. In general, the integer scheduler 50 is configured to handle the scheduling of forty (40) instructions (numbered 0-39) as shown schematically by blocks 112-120. Block 112 has forty entries that generally contain vectors associated with forty instructions that must be scheduled. The remaining block 114-120 generally represent read word lines associated with the entries in block 112. Each read word line is assigned a location (0-39) that corresponds to one of the forty vectors in block 112. Integer scheduler 50 read word lines are implemented in a fully decoded form (i.e., no decoding is required).

As a given instruction is executed (and the instruction status is good) its vector removed or deallocated (retired) from the scheduler 50 and a new vector is inserted so that a new instruction can be scheduled. Blocks 102-110 are generally arranged in a circular configuration for continuous operation. As such, the interconnection of blocks 102-110 does not have a specific beginning or end. A description of blocks 102-110 is set out below without regard for the order of the individual blocks. As discussed above, the interconnections between blocks 102-110 can be implemented with multiple read word lines, (e.g., one or more read word line per scheduler entry). Although lines 132-142 are shown as single lines for matters of simplicity, they represent one or multiple read word lines.

In general, ancestry table 110 tracks which instruction is the oldest and produces an output 140 to identify this instruction. The post wake logic circuit 106 is generally configured to determine which instructions are ready based on the current match input 134 and drives the ready and oldest lines 136 and 138. The picker 110 receives the ready and oldest output lines 136, 138, picks one or more instructions for execution and drives picker output lines 142. The wake array logic circuit 102 generally determines the destination address of the instruction that corresponds to the picked scheduler entry. This destination address is compared to all source addresses (e.g., 4 sources for each entry in the scheduler 50). The wake array logic circuit 102 identifies a match between any of the source addresses and destination addresses. A match indicates that these sources will be available within a number of clock cycles since the picked instruction will be executed and the location will have valid data. The wake array logic circuit 102 of completes the loop by driving the current match input 134 via a latch circuit 104. A more detailed description of each block is set out below.

The post wake logic circuit 106 is generally configured to determine which instructions are ready. An instruction can be considered “ready” when all necessary resources are available. During instruction execution, typical resources include “source” information (input information) generally retrieved from a source memory location. Results from instruction execution are stored in a “destination” memory location. A given instruction will typically require one or more sources. A given source is considered available if the data at that memory location is speculatively valid. Assume for example, a given instruction requires two different sources, (such as an “ADD” instruction that adds two sources and places the result in a destination). Each of these sources must have speculatively valid data before the instruction can be considered ready. Assume for example, instruction “A” is using the destination (or result) of another instruction “B” as one of its sources “C.” If instruction “B” is scheduled for execution, then source “C” is speculatively valid because the execution result of instruction “B” maybe itself speculative (not valid). Depending on the instruction set, a given instruction can require more than two sources. In this particular example, the instruction set for the processor core shown in FIG. 1 may have instructions requiring up to four sources.

The post wake logic circuit 106 receives current match input lines 132 from the latch circuit 104 as will be discussed in greater detail below. The post wake logic circuit 106 can also receive oldest bus 140 from the ancestry table circuit 110. Based on these inputs, the post wake logic circuit 106 drives ready and oldest output lines as shown by lines 136 and 138.

In this example, current match input lines 132, 134 and the oldest bus 140 are combined through the post wake logic circuit 106 and the picker logic circuit 108 to generate forty separate read word lines. Each read word line can have a logical value of 0 or 1. The ready output lines 136 identify all instructions that are ready. If instructions corresponding to entries 0, 4 and 12 are ready, then lines 0, 4 and 12 will be set to logical value 1. The remaining lines will be set to logical value 0. The oldest instruction will have a logical value 1 on its corresponding oldest bus 140. For example, if instruction 14 is the oldest, and it is ready, then read word line 14 will be set to logical value 1 and the remaining read word lines will be set to logical 0.

The picker 110 receives the ready and oldest output lines 136, 138 and drives picker output lines 142. The picker 110 uses two basic criteria for picking an instruction for execution. The picker 110 will select the oldest instruction, only if that instruction is ready, otherwise the picker uses a random function to pick instructions from all available instructions that are ready.

In this example, the scheduler 50 is used in connection with a four-issue processor core. Accordingly, picker 108 is configured to pick four (4) instructions for execution. Several scenarios can be used to pick instructions for execution in accordance with some basic criteria, aside from just random selection. Assume for example that ten (10) instructions are ready, corresponding to entries 1, 2, 4, 6, 7, 9, 11, 14, 19 and 25, and that none are the oldest. The picker 50 can select instructions based on instruction position, highest numeric entry or lowest numeric entry, and/or instruction type. Instruction types can be classified in variety categories such as: i) EX (executable instructions) such as add, subtract, multiply, divide and shift and ii) AG—load/store based instructions (e.g., instructions that require address calculations).

Continuing with this example, picker 108 will select the highest and lowest entries, 1 and 25, and then randomly select one EX instruction and one AG instruction from the remaining entries. It should be understood that the instruction type can be supplied via a variety of methods. It should be understood that other instruction picking approaches can be used without departing from the scope of this disclosure. It should also be understood that picker 108 can be configured to select four entries or picker 108 can be divided into four independent picker units. Each picker unit can select and instruction for execution. Each picker unit can run independently and can drive its own set of forty (40) read word lines.

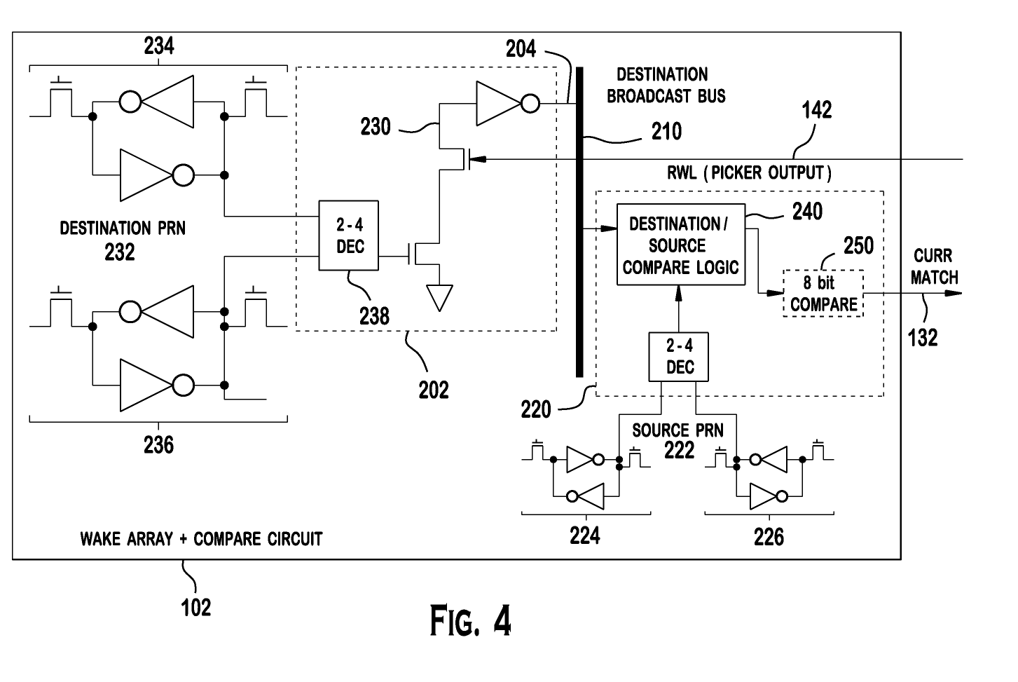

As explained briefly above, ancestry table 110 generally tracks which instruction is the oldest and produces an output to identify this instruction. In this example, ancestry table 110 drives the oldest bus 140 in one hot format (one line for each bit). The oldest instruction will have a logical value 1 on its corresponding oldest entry. For example, if instruction 14 is the oldest then oldest bus 140-bit 14 will be set to logical value 1 and the remaining bits of oldest bus 140 will be set to logical 0. A more detailed discussion of decoding from binary into one-hot format is set out below in connection with FIG. 4.

The picker output 142 is fed to the wake array logic circuit 102. As explained above, the picker output identifies specific scheduler entries that are picked for execution (picker output 142 read word lines to the wake array logic circuit 102). The wake array logic circuit 102 determines the destination address of the instruction that corresponds to the picked scheduler entry. In this example, the destination address is a physical register number (PRN). The destination PRN is compared to all source PRNs, (4 sources for each entry in the scheduler 50). The wake array logic circuit 102 identifies a match between any of the source PRNs match and destination PRN and drives the current match input 134 via a latch circuit 104 as discussed in detail below.

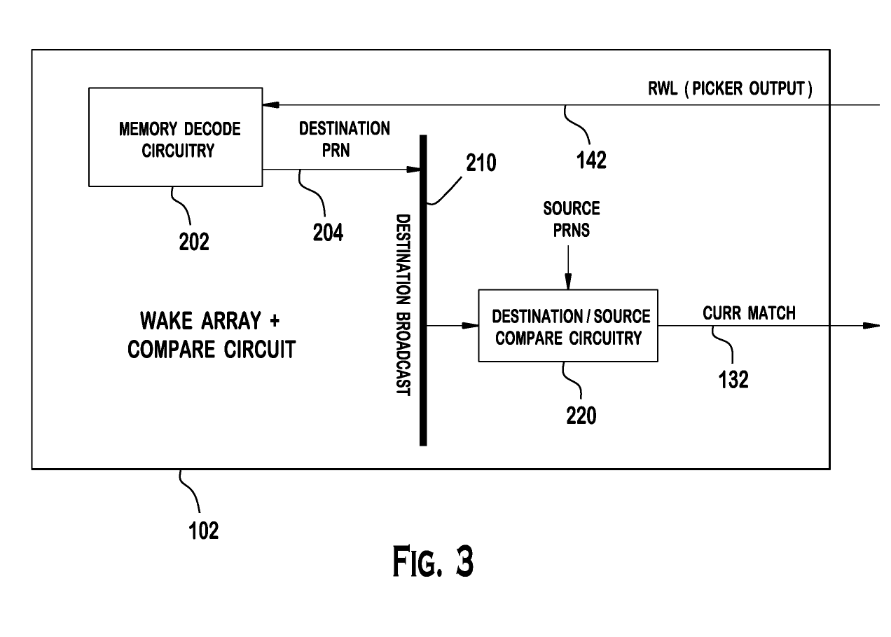

FIG. 3 is a simplified block diagram of the wake array logic circuit 102. A logical 1 on picker output line 142 signifies that a particular entry has been picked. The picker output 142 is fed into memory decode circuit 202. It should be understood that the picker output 142 can also be routed to other circuitry. For example, the picker output 142 can be routed to circuitry that causes the execution of the picked instruction via one of the pipelines 40-46 (FIG. 1). In this example, the memory decode circuit 202 generates an address output 204 which is coupled to the destination broadcast bus 210. The address output 204 is the destination PRN of the picked instruction that corresponds to read word line 142. Since this particular instruction was picked for execution, the destination of this instruction will be valid within a fixed number of clock cycles. For example, using the processor core 20 shown in FIG. 1, the destination associated with this instruction will be valid within a number of clock cycles depending on the processor architecture used (e.g., two clock cycles).

A destination/source compare circuitry 220 is also coupled to the destination broadcast bus 210. The destination/source compare circuitry 220 compares the destination associated with the picked instruction with each source associated with each entry in the scheduler 50. The destination/source compare circuitry 220 drives the current match input lines 132 that are ultimately coupled to the post wake logic circuit 106. In this example, the scheduler 50 can track forty (40) entries, (i.e., forty (40) instructions). Each instruction can have up to four (4) sources. Accordingly, the destination/source compare circuitry 220 is configured to drive current match input lines 132 indicating that up to 160 sources match the destination of the picked instruction, (e.g., 160 current match input lines). The current match input lines 132 allow the post wake logic circuit 220 to determine which instructions are ready as discussed above.

As shown in FIG. 2, the latch circuit 104 is disposed between the wake array logic circuit 102 and the post wake logic circuit 106. Latch circuit 104 generally provides a latching function. The output, current match input 134 to the post wake logic circuit 106, is latched and provides a steady input to the post wake logic circuit 106. This allows the allows wake array logic circuit 102 to reset for the next cycle without affecting the current match input 134 to the post wake logic circuit 106. In this particular example, the latch circuit 104 is implemented with B-phase latches, which are open when the clock is a logic 0.

FIG. 4 shows a more detailed drawing of the wake array logic circuit 102. As described above, a logical 1 on picker output line 142 signifies that a particular scheduler entry has been picked. The picker output 142 is fed into the memory decode circuit 202. In this example, the memory decode circuit 202 includes input circuitry 230 that is coupled to a memory location 232. In this example, only two bits 234, 236 of the memory location 232 are shown. It should be understood that additional bits may be required to fully specify a given PRN. In this example a 2-4 decoder 238 is used in order to conserve power. The basic operation of a 2-4 decoder is shown in table 1 below:

TABLE 1

| Input A | Input B | Y0 | Y1 | Y2 | Y3 |
|---|---|---|---|---|---|
| 0 | 0 | 1 | 0 | 0 | 0 |
| 0 | 1 | 0 | 1 | 0 | 0 |
| 1 | 0 | 0 | 0 | 1 | 0 |
| 1 | 1 | 0 | 0 | 0 | 1 |

As shown in Table 1, the 2-4 decoder converts a 2 bit input (A and B) to a 4 bit output (Y0-Y3). The 2-4 decoder outputs only a single line with a logical 1 indicating a given value. This is generally referred to as a “one-hot” format and is advantageous since only a single line is driven high regardless of the numerical address (i.e., binary 11 is decoded into 0001). This results in lower power dissipation during the subsequent compare process since fewer bits are switched. As noted above, additional data bits may be required to fully decode the destination PRN for the picked instruction. Accordingly, additional decoder banks can also be used to decode from binary to one-hot format.

The destination PRN in one-hot format is placed on the destination broadcast bus 210. Since this particular instruction was picked for execution, the destination of this instruction will be valid within a fixed number of clock cycles, (e.g., two cycles). Destination/source compare circuitry 220 is also coupled to the destination broadcast bus 210. The destination/source compare circuitry 220 compares the destination PRN with each source PRN for each entry in the scheduler 50.

In this example, the destination/source compare circuitry 220 is implemented with destination/source compare logic 240 which compares the destination PRN with all source PRNs. In its simplest form, destination/source compare logic 240 could contain a bank of 160 comparators that compare each source PRN to the destination PRN and directly drive the current match input lines 132. In this example, the source memory decoding circuitry also uses a 2-4 decoder 228. Only two bits 234, 236 of the memory location 222 are shown for purposes of clarity. It should be understood that additional bits may be required to fully specify a given PRN. It should also be understood that such circuitry can be duplicated to provide compare functionality additional bits for longer source PRNs, (e.g., 8-bits).

The destination/source compare circuitry 220 can be implemented with multiple compare stages. For example, if 4 bits of the source PRN matches the destination PRN, a subsequent compare can be carried out to determine if there is a match of all bits of the two PRNs (e.g., 8-bit compare) as shown by block 250.

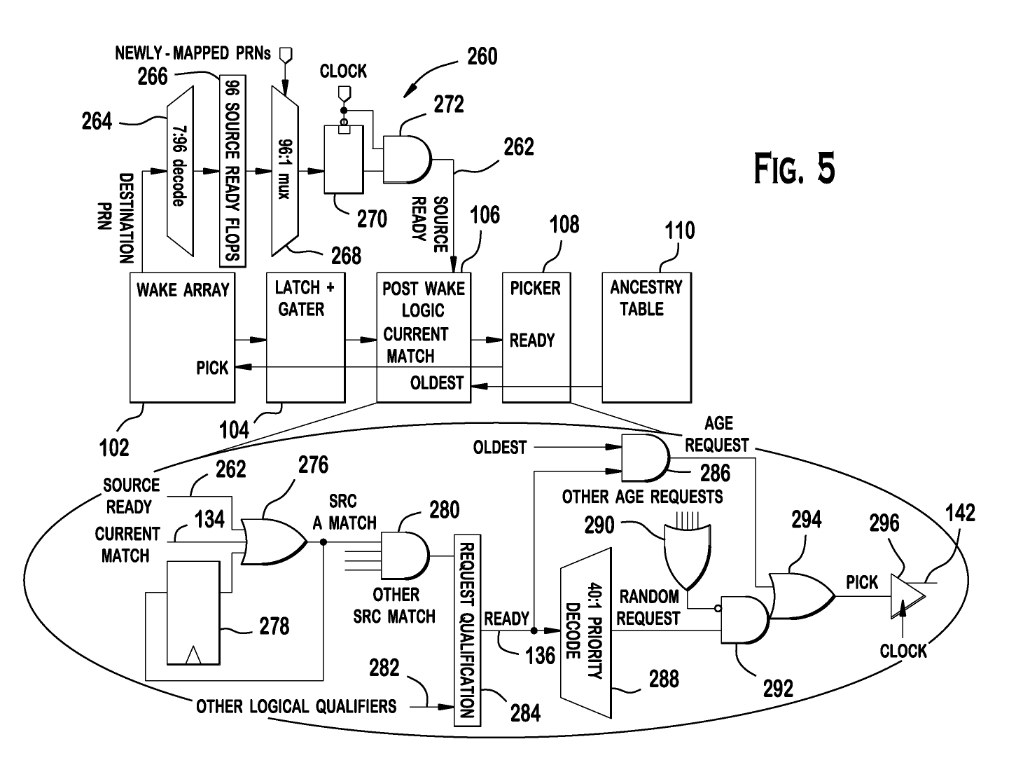

FIG. 5 is a block diagram showing source ready circuitry 260. As described above, a newly mapped destination PRN is compared to all source PRNs, (4 sources for each entry in the scheduler 50). The wake array logic circuit 102 identifies a match between any of the source PRNs match and destination PRN and drives the current match input 134 The source ready output 262 and current match input 134 are used by the post wake logic circuit 106 to drive the ready line 136.

A newly woken up destination PRN from the wake array logic circuit is sent to the source ready logic circuit and is decoded via a 7:96 decoder 264 coupled to 96 source ready flip flops 266. It should be understood that 7 bits could be decoded into 128 valid addresses. However, in this particular example, only 96 PRNs are used. The source ready flip flops serve to keep track of all sources inside the scheduler that are ready. The output of the source ready flip flops 266 are fed into a 96:1 multiplexer 268 which drives flip flop 270. The source ready output 262 is gated via AND gate 272. The source ready circuitry 260 is used to detect the readiness of newly arrived sources of new instructions that have just been dispatched to the scheduler 50.

FIG. 5 also includes a block diagram of circuitry contained in the post wake logic circuit 106 and picker 108. The source ready and current match signals 262 and 134 are input to OR gate 276 along with gating signal 280 via flip flop 278. The output of OR gate 276 drive AND gate 280. Other logical qualifiers 282 (e.g., other sources) are then combined and the ready output 136 is generated via block 284. In order for a given scheduler entry to be considered ready, all sources must be available. It should be understood that the circuitry discussed above must be replicated for multiple sources and for multiple scheduler entries.

The ready output 136 (40 lines) is coupled to a 40:1 decoder 288. Each ready output line is checked to determine if the associated scheduler entry is the oldest via AND gate 286. If the entry is the oldest, the pick output is overridden (i.e., the entry is picked) via OR gate 294. Otherwise, the entry is picked based on random parameters via OR gate 290 and AND gate 294. Each picker output line (e.g., 40 lines) are driven by a driver 142.

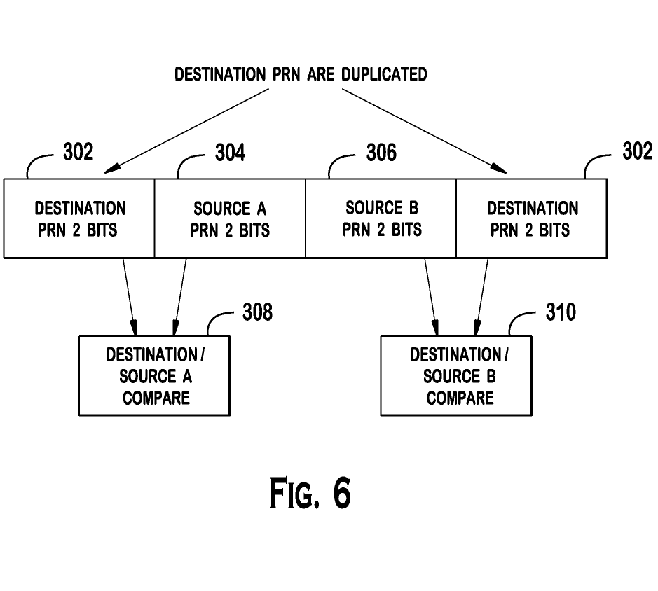

FIG. 6 is a block diagram showing duplication of the destination PRN to allow a 1:160 compare. In its simplest form, the destination/source compare logic 240 could compare the destination PRN to 160 source PRNs. However, this creates a wiring problem in that 160 wires are required for each bit in the compare.

FIG. 5 illustrates a structure where the destination PRN 302 is duplicated for each pair of source PRNS 304, 306. The output of the compare is shown by block 308, 310. Performing two source compares with a single duplicated destination PRN simplifies the physical wiring needed to route the destination PRN to a large number (e.g., 160) source PRNs. It should be understood that additional compare operations may be required to implement a compare with more than 2 bits.

It should be understood that many variations are possible based on the disclosure herein. Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the present invention.

What is claimed is:

1. An apparatus for scheduling execution of instructions in a multi-issue processor, the apparatus comprising:
logic circuitry configured to track a plurality of entries corresponding to a plurality of instructions to be scheduled, each instruction having at least one associated source address and a destination address, the logic circuitry being configured to drive a ready input indicating an entry that is ready for execution based on a current match input;
picker circuitry configured to pick an instruction for execution based the ready input; and
compare circuitry configured to determine the destination address for the picked instruction, compare the destination address to the source address for all entries and drive the current match input.

2. The apparatus of claim 1 further comprising an age circuit configured to determine an oldest entry and drive an oldest input, wherein the picker circuitry is configured to pick an instruction for execution based the ready input and the oldest input.

3. The apparatus of claim 1 wherein the entries are tracked in a fully decoded format.

4. The apparatus of claim 1 wherein the compare circuitry further comprises first memory decode circuitry configured to decode the destination address for the picked instruction and second memory decode circuitry configured to decode source addresses for each entry.

5. The apparatus of claim 4 further comprising a destination/source compare circuitry configured to compare the destination address for the picked instruction to all source addresses for each entry and drive the current match input.

6. The apparatus of claim 5 further comprising a destination broadcast bus configured to distribute the destination address to the destination/source compare circuitry.

7. The apparatus of claim 4 wherein the first memory decode circuitry further comprises a decoder configured to decode the destination address for the picked instruction into a one-hot format.

8. The apparatus of claim 4 wherein the second memory decode circuitry further comprises a decoder configured to decode the source addresses for each entry into a one-hot format.

9. The apparatus of claim 4 wherein the compare circuitry further comprises at least two stages configured to generate an 8-bit compare.

10. The apparatus of claim 4 wherein the compare circuitry is configured to replicate a portion of the destination address for comparison to multiple source addresses.

11. A method for scheduling execution of instructions in a multi-issue processor, the method comprising:
tracking a plurality of entries corresponding to a plurality of instructions to be scheduled, each instruction having at least one associated source address and a destination address and driving a ready input indicating an entry that is ready for execution based on a current match input;
picking an instruction for execution based the ready input; and
determining the destination address for the picked instruction, comparing the destination address to the source address for all entries and driving the current match input.

12. The method of claim 11 further comprising determining an oldest entry, driving an oldest input and picking an instruction for execution based the ready input and the oldest input.

13. The method of claim 1 wherein the entries are tracked in a fully decoded format.

14. The method of claim 1 further comprising decoding the destination address for the picked instruction and decoding source addresses for each entry.

15. The method of claim 14 further comprising comparing the destination address for the picked instruction to all source addresses for each entry and driving the current match input.

16. The method of claim 15 further comprising distributing the destination address to multiple compare circuits.

17. The method of claim 14 further comprising decoding the destination address for the picked instruction into a one-hot format.

18. The method of claim 14 further comprising decoding the source addresses for each entry into a one-hot format.

19. The method of claim 14 further comprising providing at least compare two stages configured to generate an 8-bit compare.

20. The method of claim 14 further comprising replicating a portion of the destination address for comparison to multiple source addresses.

21. A computer readable media including hardware description language (HDL) code stored thereon, and when processed generates intermediary data to create mask works configured to perform a method for scheduling execution of instructions in a multi-issue processor, the method comprising:
tracking a plurality of entries corresponding to a plurality of instructions to be scheduled, each instruction having at least one associated source address and a destination address and driving a ready input indicating an entry that is ready for execution based on a current match input;
picking an instruction for execution based the ready input; and
determining the destination address for the picked instruction, comparing the destination address to the source address for all entries and driving the current match input.
